(19) United States
(12) Patent Application Publication
(10) Pub. No.: US 2012/0309307 A1
(43) Pub. Date: Dec. 6, 2012

(54) NFC METHOD, ARRANGEMENT AND SETUP

(76) Inventor: Nate D'Amico, Woodside, CA (US)

(21) Appl. No.: 13/485,930

(22) Filed: Jun. 1, 2012

Related U.S. Application Data
(60) Provisional application No. 61/493,287, filed on Jun. 3, 2011.

(51) Int. Cl. H04B 5/00; G06K 19/02; G06K 19/077

(52) U.S. Cl. 455/41.1; 235/488

(57) ABSTRACT

Methods and setups are provided that facilitate the identification of a target item from an arrangement of items. Each item of the arrangement has a different corresponding NFC tagging device attached thereto. Electronic equipment may be provided comprising a NFC scanner of a read range. The NFC tagging device of the target item and the NFC tagging device of at least one nontarget item in the arrangement may be positioned such that they are simultaneously located within the read range of the NFC scanner. By physically shielding the tagging device of the at least one nontarget item from the NFC scanner, a human user may activate the NFC scanner to communicate with the NFC tagging device of the target item. As a result, the NFC scanner may identify and distinguish the target item from one or more nontarget items of the arrangement.

### CROSS REFERENCE TO RELATED APPLICATIONS

This application claims priority to U.S. Provisional Patent Application Ser. No. 61/493,287, entitled “PRINT-NFC METHOD AND APPARATUS,” filed on Jun. 3, 2011, by inventor Nate D'Amico, the disclosure of which is incorporated by reference in its entirety.

### BACKGROUND

The invention generally relates to Near Field Communication (NFC) methods, arrangements and setups. More particularly, the invention relates to NFC technology that allows a NFC scanner to identify a target item from an arrangement of items that also includes nontarget items within the read range of the scanner.

As the cost of production associated with radio frequency identification (RFID) technology has gone down, adoption of near field communication (NFC) technology is becoming widespread. In the past, RFID technology has been dominated by tagging devices that require the use of semiconductor chips. Looking forward, however, chipless RFID tagging devices are expected to take over the majority of RFID devices for future mass-market applications. Chipless tagging devices are generally less expensive to manufacture and to implement than semiconductor chips because the devices and their associated antenna are printed directly on a surface. Examples of chipless printed RFID technology is described, for example, in U.S. Pat. No. 7,299,990 to Hoshina and in U.S. Pat. No. 7,341,196 to Sandrini et al.

RFID technology has been used by organizations such as WalMart for inventory management and logistical purposes. In addition, RFID technology has been used for all sorts of identification needs on all sorts of objects. Examples of current RFID tagging usage include, credit and identification cards, toll systems, palette of products, animal tracking and more.

In addition, the RFID Consortium has been formed comprising member companies involved with RFID technology. The goal of the RFID Consortium has been to advance RFID technology to the point where “item level” tagging is possible. Item level tagging technology allows tracking of individual items (as opposed to groupings of like items, e.g., on palettes) wherein each item is uniquely labeled with a single RFID tagging device.

Item level tagging represents a possible future replacement for universal product code (UPC) technology on a wide range of consumer goods. Instead of having to have a scanner that visually reads a UPC barcode to interpret the value of the code for lookup, RFID technology provides an advanced form of automated tag reading. Unlike UPC barcode technology, RFID technology requires neither line-of-sight alignment nor physical contact between the scanner and the tagged items. It has been proposed that all consumer items for purchase at retail locations be RFID tagged in the future. Instead of having to have cashiers scan individual items at checkout counters before exiting a retail location, consumers would simply walk past scanners located near exits of the retail locations for reading the RFID tagging devices on the products they are to purchase.

There are three general types of RFID tagging devices—passive, active, and semi-passive. The active and semi-passive tagging device types require their own power source to generate and send a readable signal via the tagging devices' antennae. Purely passive tagging devices, on the other hand, do not require their own power source. Instead, passive tagging devices are activated when an electromagnetic signal generated by a nearby NFC scanner inductively powers them to generate the readable signal in response. Typically, signals generated by passive RFID tagging devices have read distances of a few inches.

Currently, NFC technology is used much in the same manner as one would use hand held barcode scanners. For example, each item having a single NFC tagging device attached thereto may be brought individually into proximity with an NFC scanner for identification. Alternatively, the NFC scanner may be brought successively into proximity with individual items, each having a single NFC tagging device attached thereto.

The rising popularity of NFC tagging devices has cell phone manufacturers planning to equip future cell phones with RFID scanners much in the same way that they have added camera and GPS functionality to current cell phones. Manufacturers such as Nokia and Samsung have already begun building handsets that incorporate NFC scanning functionality. Such functionality allows a cellphone user to read NFC tagging devices on retail items, billboards or ad signage and to provide the user with an interactive experience powered by software residing in the cellphone.

Privacy concerns represent a hurdle associated with RFID technology in certain contexts. For example, consumer and privacy activists have objected to the use of RFID tagging devices on passport and other identification. Researchers have demonstrated that it is possible to “hack” or steal information from an identification card containing RFID tagging device by surreptitiously walking by and directing an RFID scanner toward an unsuspecting individual carrying the identification card. As a result, identity theft may occur.

To overcome such objections, RFID signal shielding products such as passport holders, wallets and paper sleeves are now available. Manufacturers of such products include Chase and Toppan. In some instances, RFID signal shielding products may be produced via printing technologies similar to that used to produce chipless tagging devices.

Another problem arises when a user attempts to use an NFC scanner to scan one of a plurality of NFC tagging devices located within close proximity to each other. Although NFC tagging devices have short read distances, the devices in close proximity to each other do not lend themselves to be read individually without some sort of software/hardware/user intervention to distinguish between the devices. Such software/hardware/user intervention tends to diminish use experience.

Accordingly, opportunities exist to overcome disadvantages associated with known NFC and RFID technologies.

### SUMMARY

In general, the invention relates to a method of identifying a target item from an arrangement of items. Each item of the arrangement has a different corresponding NFC tagging device attached thereto. Electronic equipment comprising a NFC scanner of a read range is positioned relative to the arrangement such that the NFC tagging device of the target item and the NFC tagging device of at least one nontarget item in the arrangement are simultaneously located within the read range of the NFC scanner. In addition, the tagging device of the at least one nontarget item is physically shielded from the NFC scanner. The NFC scanner is activated to communicate with the NFC tagging device of the target item. As a result, the NFC scanner identifies the target item from the arrangement.

In another embodiment, the invention provides an arrangement of items for identification by electronic equipment comprising a NFC scanner of a read range. The arrangement comprises a plurality of items, a different corresponding NFC tagging device attached to each of the items, and physical shielding interposed between the NFC tagging devices. The items may be positioned relative to each other at a distance that does not exceed the reed range of the NFC scanner. The physical shielding ensures that the item closest to the NFC scanner is identified as the target item when the electronic equipment scans the items.

In a further embodiment, a setup is provided for identifying a target item from an arrangement of items, wherein each item has a different corresponding NFC tagging device attached thereto. The setup includes the arrangement of items and electronic equipment comprising a NFC scanner having a read range. The NFC scanner and the arrangement together are positioned such that the NFC tagging device of target item and the NFC tagging device of at least one nontarget item in the arrangement are simultaneously located within the read range of the NFC scanner. The tagging device of the at least one nontarget item is physically shielded from the NFC scanner. Activation of the NFC scanner allows the NFC scanner to communicate with the NFC tagging device of the target item.

### BRIEF DESCRIPTION OF THE DRAWINGS

The present invention can best be understood in connection with the accompanying drawings. The invention is not limited to the precise embodiments shown in drawings, which include:

FIG. 1 depicts a multilayer approach of assembling the printed, shielding and tagging materials.

FIG. 2 depicts the same multi layered approach as FIG. 1 with a different tagging application.

FIG. 3 depicts a single layer of NFC shielding material on which printing may be carried out.

FIG. 4 depicts an example of how many of the pages outlined in FIGS. 1-3 may be bound.

### DETAILED DESCRIPTION OF THE INVENTION

### Definitions and Overview

Before describing the present invention in detail, it is to be understood that the invention is not limited to specific brands or types of electronic equipment, as such may vary. It is also to be understood that the terminology used herein is for describing particular embodiments only, and is not intended to be limiting.

In addition, as used in this specification and the appended claims, the singular article forms “a,” “an,” and “the” include both singular and plural referents unless the context of their usage clearly dictates otherwise. Thus, for example, reference to “an item” includes a single item as well as an assembly of items, reference to “a tagging device” includes a plurality of tagging devices as well as a single tagging device, and the like.

In this specification and in the claims that follow, reference will be made to a number of terms that shall be defined to have the following meanings, unless the context in which they are employed clearly indicates otherwise:

The term “attach” and its variants, e.g., “attached,” “attachment,” and “attaching,” are used herein in their ordinary sense and may be synonymously used to mean “join,” “fasten,” “connect,” “affix,” and/or the like. Unless specified with particularity, the term “attach,” when applied to an arrangement of items, does not necessarily mean that the items are attached directly to each other. Instead, the items may be indirectly attached to each other, e.g., via an intermediary. For example, pages and other items may be indirectly attached to each other via an intermediary binding.

The terms “electronic,” “electronically,” and the like are used in their ordinary sense and relate to structures, e.g., semiconductor microstructures, that provide controlled conduction of electrons or other charge carriers, e.g., holes.

Similarly, the term “equipment” is used in its ordinary sense and refers to anything kept, furnished, or provided for a specific function. For example, the term “electronic equipment” may refer to hardware and/or software whose operation involve controlled conduction of electrons in a silicon chip in a digital and/or analog manner to carry out the functionality of the hardware and/or software.

The term “internet” is used herein in its ordinary sense and refers to an interconnected system of networks that connect computers around the world via the TCP/IP and/or other protocols. Unless the context of its usage clearly indicates otherwise, the term “web” is generally used in a synonymous manner with the term “internet.” The term “internet” calls forth all equipment associated therewith, e.g., microelectronic processors, memory modules, storage media such as disk drives, tape backup, and magnetic and optical media, modems, routers, etc.

The terms “near field communication” or “NFC” are used herein in their ordinary sense and refers to technology that employ a set of standards for smartphone and similar devices to establish radio communication with each other, e.g., by bringing them into contact or close proximity with each other. The read range of NFC technology is usually up to about 10 centimeters, but on occasion may extend further. Applications of NFC technology include, e.g., contactless transactions, data exchange, and simplified setup of more complex communications such as Wi-Fi.

As a related matter, the terms “radio frequency identification” or “RFID” are also used in their ordinary sense and refers to the use of a wireless non-contact system that uses radio-frequency electromagnetic fields to transfer data from a tagging device attached to an item to a scanner, typically for the purposes of automatic identification and tracking. Unlike bar code technology, the tagging device does not need to be within line of sight of the scanner.

Persons of ordinary skill in the art will recognize that the terms “NFC” and “RFID,” in some instances, may be interchangeably used herein. In other instances, the term “NFC” may be considered a subset of “RFID,” e.g., when “NFC” is used synonymously with “passive RFID.”

“Optional” or “optionally” means that the subsequently described circumstance may or may not occur, so that the description includes instances where the circumstance occurs and instances where it does not.

The terms “substantial” and “substantially” are referred to herein in their ordinary sense and are used to describe matters that are, e.g., considerable in importance, value, degree, amount, and/or extent. For example, when items are referred to as “substantially” identical in size, the items should not differ in size by more than about 10%. Similarly, when items that are substantially identical in shape may be approximately or precisely identical in shape. Other uses of the term “substantially” involve an analogous definition.

In general, the invention relates to methods and setup that facilitate the identification of a target item from an arrangement of items. Each item of the arrangement has a different corresponding NFC tagging device attached thereto, e.g., passive or active RFID tagging devices. Electronic equipment may be provided comprising a NFC scanner of a read range. The NFC tagging device of the target item and the NFC tagging device of at least one nontarget item in the arrangement may be positioned such that they are simultaneously located within the read range of the NFC scanner, e.g., when the tagging devices are positioned flush against each other. By physically shielding the tagging device of the at least one nontarget item from the NFC scanner, a human user may activate the NFC scanner to communicate with the NFC tagging device of the target item. As a result, the NFC scanner may identify and/or distinguish the target item from one or more nontarget items of the arrangement.

The invention also provides an arrangement of items for identification by electronic equipment comprising a NFC scanner of a read range. The arrangement comprises a plurality of items, a different corresponding NFC tagging device attached to each of the items, and physical shielding interposed between the NFC tagging devices. The items may be positioned relative to each other at a distance that does not exceed the read range of the NFC scanner. The physical shielding ensures that the item closest to the NFC scanner is identified as the target item when the items are scanned by the equipment while shielding interference from other tagging devices.

The invention may be used in conjunction with different types of items. For example, items may be substantially identical in shape and size, e.g., sheets of materials, attached or unattached to each other. The items may be provided in the form a tightly or loosely bound arrangement of printed material, e.g., as a book, magazine, newsletter, catalog, calendar, etc., or in the form of an unbound arrangement, e.g., as a loose stack of individual items, printed pages, etc. The items can be made of any type of material, such as paper, cloth, plastic, etc.

The invention may also be used with a variety of different electronic equipment that includes NFC scanning functionality. For example, handheld apparatuses such as those wireless communication. Such handheld apparatuses may comprise a telephone or a tablet computer. Such apparatuses may include user interfaces such as keyboards, joysticks, mouses, and/or touchscreens.

Typically, the invention is carried out in a manner that does not require a human user intervention to distinguish between a plurality of items within the read range of the scanner. For example, the invention may be carried out without having the NFC scanner identifying or even detecting any nontarget item. Optimally, no more than one target item is identified per activation of the NFC scanner.

Once scanning has commenced, the electronic equipment may use the target item's identification information to carry out any of a number of additional functions. For example, the equipment may lookup information pertaining to the target item, play audio and/or visual media, bookmark identifying information relating to the target item, clip and/or digitally store a coupon associated with the target item, access a link to additional content, and/or conduct a commercial transaction associated with the target item. Optionally, the additional functions may involve accessing the internet, other networks, and/or standalone devices.

Physical shielding may be carried out using any of a number of materials that shield electromagnetic signals associated with NFC and/or RFID. Typically, an electrically conductive material is use. The material comprise electronically conductive components, e.g., metals, and/or ionically conductive, e.g., e.g., salt water. Alternatively, nonmetallic conductive materials such as indium tin oxide or other ceramics and various forms of carbon may be used. The shielding may have any of a number of different form factors, but sheets may be preferably used in some instances. Exemplary conductive materials include foils comprised of aluminum, tin, copper, or other metals, metallized or other coated plastics, cellulosic or other polymeric materials impregnated with conductive particles.

The invention is of commercial significance because as the cost of NFC tagging devices comes down in price “item level” tagging becomes cost effective. Item level tagging and NFC ready equipped smart phones will open up a whole new world of possibilities for interactivity and many possible solutions. For example, while interacting with tagged items, a user might wish to scan/read one or more of them in succession. Due to the read ranges on ordinary passive NFC tagging device, the users NFC scan may pick up multiple tagging devices at the same time. The user would be prompted by the scanner to choose which item they meant to scan. This leads to an extremely tedious and suboptimal user experience. Due to irregularities in NFC scanning hardware/software, the invention provides a means to deliver an optimal user experience is to NFC utilize shielding materials with the tagged items such that only the intended tagging device is read.

The invention may be used in conjunction with items that may include interactive pages, e.g., in magazines, newspapers, books, catalogs, newsletters, documents, photographs, direct mailers, etc. A few books and magazines have already inserted single tagging devices into spines and covers in order to provide new levels of tracking and interactivity. Hard cover products such as books with concealed security devices are described, for example, in U.S. Pat. No. 7,411,499 to Nichols. Content producers who distribute their material in printed form may be able to take advantage of cheap item level NFC tagging via printable antennas that are printed directly on multiple pages and other inserted materials. This will allow their scanners to interact electronically with the tagged items. The invention may be used whenever tagging devices are in close proximity to each other and the NFC scanner may confuse and/or pick up signals from the tagging devices.

The invention may also be used in conjunction with stacked items, e.g., stacks of business, trading, or game cards. Cards of varying sorts could take advantage of item level NFC tagging and will allow each card to carry a tagging device. Each tagging device could provide experiences such as: import contact information from a business card, lookup further information from the web or local database, and/or play accompanying media such as video/audio. In the case of game cards, a user, having scanned a particular and picked up signals from the tagging device attached thereto, may experience interactive activities such as engaging in peer-to-peer gaming.

Similarly, collectors of media content such as albums, photos, compact disks, digital video disks, and scrapbook makers could take advantage of tem level NFC tagging and will allow each item to be tagged to provide a range of interactive experiences. Exemplary experiences include inventory and lookup of media assets within an album, lookup further information from the web or local database, and playing accompanying media such as video/audio.

With multiple items being in close proximity to each other, the invention provide a means to read only the tagging device the user is expecting to be read. As alluded to above, the invention employs NFC shielding material between and around the tagging devices. In some instances, only the tagging device on top of a stack may be read according to user expectation.

To provide some background regarding to how NFC tagging may be combined with printed matter, it should be noted that there are examples of various ways in which one might utilize tagged items with printed matter, due to the variety of ways in which printed material is assembled and distributed. For example, a content producer may attach tagging devices to opposite sides a single sheet paper. That is, the content producer might desire to place a tagging device on each page. When a plurality of sheets are provided, tagging devices may be attached to successive pages, e.g., on pages 1, 3, 5, etc., or to spaced out pages, e.g., 1, 23, 29, etc. While the tagging devices may serve to identify the printed content of their respective pages, the read range on NFC tagging device devices may allow the scanner to pick up multiple tagging devices at once.

As another example, it is also common in printed material such as magazines, newspapers, etc., to have inserted material. Sometimes these items are inserted via the binding/assembly process. At other times, the items may be placed in various locations on top of other material. For example, tagged cards and/or tagged inserts may be overlaid on a tagged page.

As a further example, a content producer might wish to have multiple tagging devices on the same side of a sheet of material, i.e., on the same page. In such a case, the content producer may wish to space the tagging devices at a sufficient distance apart to avoid both being read. Optionally, computer vision techniques could be combined with NFC scanning technology provide an optimal user experience.

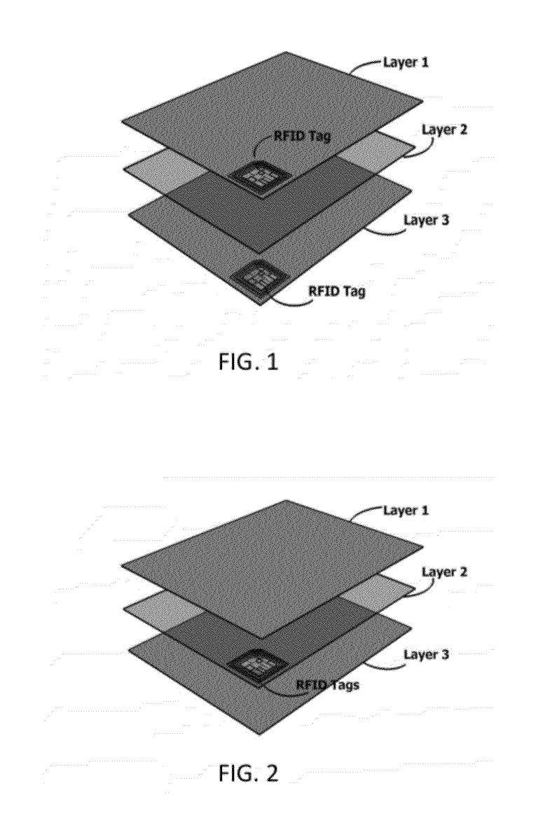

In any case, FIG. 1 shows an exemplary application of the invention in the form of a multilayer approach to assembling printed, shielding and tagging materials. As is the case with all figures referenced herein, in which like parts are referenced by like numerals, FIG. 1 is not necessarily to scale, and certain dimensions may be exaggerated for clarity of presentation.

Layer 1 is paper or some other printable material. Layer 2 represents NFC shielding material. Layer 3 is another material the backside of which is printable. NFC tagging devices may be affixed to or printed in a chipless manner on the outer printed layers.

The layers may typically be bound together to form a single page by proprietary or non-proprietary adhesives. In some cases, the layers may not be bound together but may be separate pages in a bound/grouped document.

FIG. 2 depicts the same multi layered approach as shown in FIG. 1 except that there is a difference in how the NFC tagging devices are applied. Tagging devices may be affixed to or printed such that they lie between the shielding and printed layers. The varying placement of the tagging devices depends on whether it is desirable the user visually sees the tagging device or it is hidden under the first layer. Again, the layers typically will be bound together to form a single page by adhesives. In some cases, the layers may not be bound together but might be separate pages in a bound/grouped document.

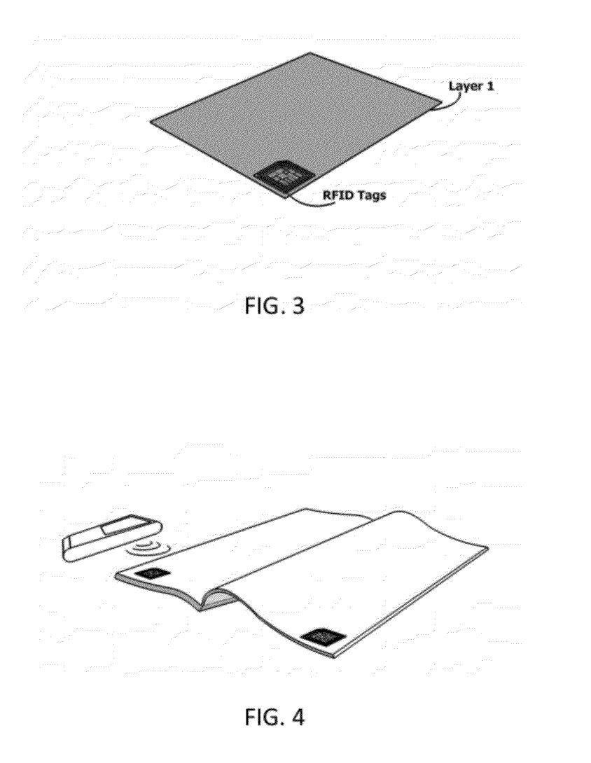

FIG. 3 depicts a single layer of NFC shielding material that can be printed on directly. Multiple NFC tagging devices are attached to or printed on in a chipless manner on both or either side of the layer. This method would be utilized by a design decision to use the shielding layer in a similar manner that a transparency film is printed/written on for overhead projectors.

FIG. 4 depicts an example of how many of the pages outlined in FIGS. 1-3 could be bound or placed together in a manner such as a book or magazine. A user equipped with an NFC scanner such as a handheld device like a cell phone can scan each page without reading the tagging devices on the backside of the page or on any of the following or preceding pages.

Variations of the present invention will be apparent to those of ordinary skill in the art in view of the disclosure contained herein. Other variations of the invention may be discovered upon engaging in routine experimentation during the ordinary course of the practice of the invention.

It is to be understood that, while the invention has been described in conjunction with the preferred specific embodiments thereof, the foregoing description merely illustrates and does not limit the scope of the invention. Numerous alternatives and equivalents exist which do not depart from the invention set forth above. In general, any particular embodiment of the invention may be modified to include or exclude features of other embodiments. Other aspects, advantages, and modifications within the scope of the invention will be apparent to those skilled in the art to which the invention pertains.

All patents mentioned herein are hereby incorporated by reference in their entireties to an extent not inconsistent with the disclosure provided above.

What is claimed is:

1. A method of identifying a target item from an arrangement of items, comprising:
(a) providing the arrangement of items, each item having a different corresponding NFC tagging device attached thereto;
(b) providing electronic equipment comprising a NFC scanner of a read range;
(c) positioning the NFC scanner and the arrangement such that
the NFC tagging device of the target item and the NFC tagging device of at least one nontarget item in the arrangement are simultaneously located within the read range of the NFC scanner, and
the tagging device of the at least one nontarget item is physically shielded from the NFC scanner; and
(d) activating the NFC scanner to communicate with the NFC tagging device of the target item, thereby allowing the NFC scanner to identify the target item from the arrangement.

2. The method of claim 1, wherein the items are substantially identical in shape and size.

3. The method of claim 2, wherein the items are attached to each other.

4. The method of claim 2, wherein each item comprises a sheet of material.

5. The method of claim 4, wherein the arrangement comprises a bound arrangement of printed material.

6. The method of claim 2, wherein each item comprises a page of material.

7. The method of claim 2, wherein the items are arranged in a stack.

8. The method of claim 2, wherein step (d) is carried out when the NFC tagging device of target item is located closer to the NFC scanner than the NFC tagging device of any nontarget item.

9. The method of claim 1, wherein the NFC tagging devices are chipless RFID tagging devices.

10. The method of claim 9, wherein the RFID tagging devices are passive.

11. The method of claim 9, wherein the RFID tagging devices are active.

12. The method of claim 1, wherein the equipment is a handheld apparatus.

13. The method of claim 12, wherein the handheld apparatus is capable of wireless communication.

14. The method of claim 12, wherein the handheld apparatus comprises a telephone.

15. The method of claim 1, wherein step (c) is carried out by a human being.

16. The method of claim 1, wherein step (d) is carried out without having the NFC scanner identifying any nontarget item.

17. The method of claim 1, wherein step (d) is carry out in a manner such that no more than one target item is identified per activation of the NFC scanner.

18. The method of claim 1, further comprising, after step (d), (e) allowing the electronic equipment to
(e1) lookup information pertaining to the target item,
(e2) play audio and/or visual media,
(e3) bookmarking identifying information relating to the target item,
(e4) clipping and/or storing a coupon associated with the target item, and/or
(e5) conducting a commercial transaction associated with the target item.

19. An arrangement of items for identification by electronic equipment comprising a NFC scanner of a read range, comprising:
a plurality of items;
a different corresponding NFC tagging device attached to each of the items, the items positioned at a distance from each other that does not exceed the reed range of the NFC scanner; and
physical shielding interposed between the NFC tagging devices such that the item closest to the NFC scanner is identified as the target item when the items are scanned by the equipment.

20. A setup for identifying a target item from an arrangement of items, comprising:
the arrangement of items, each item having a different corresponding NFC tagging device attached thereto; and
electronic equipment comprising a NFC scanner having a read range,
wherein the NFC scanner and the arrangement together are positioned such that the NFC tagging device of target item and the NFC tagging device of at least one nontarget item in the arrangement are simultaneously located within the read range of the NFC scanner, the tagging device of the at least one nontarget item is physically shielded from the NFC scanner, and activation of the NFC scanner allows the NFC scanner to communicate with the NFC tagging device of the target item, thereby allowing the NFC scanner to identify the target item from the arrangement.
